(19) United States
(12) Patent Application Publication
(10) Pub. No.: US 2005/0210878 A1
(43) Pub. Date: Sep. 29, 2005

(54) System and method for storing, disseminating, and utilizing energy in the form of gas compression and expansion including a thermo-dynamic battery

(76) Inventor: Daniel Ashikian, Los Angeles, CA (US)

Correspondence Address: Joseph R. Evanns;Evanns & Walsh, Ste 206, 119 N. San Vicente Blvd., Beverly Hills, CA, 90211, US

(21) Appl. No.: 11/126,920

(22) Filed: May 10, 2005

Related U.S. Application Data
(63) Continuation-in-part of application No. 10/833,958, filed on Apr. 28, 2004.
Application No. 10/833,958 is a continuation-in-part of application No. 09/854,682, filed on May 15, 2001, now abandoned.

(51) Int. Cl. F01K 1/00; F02B 73/00; F01K 3/00; F01K 23/00; F01B 21/04

(52) U.S. Cl. 60/659

(57) ABSTRACT

Thermo-dynamic battery storage unit for converting compressed gas energy into consumable electrical power for application uses with any device that requires battery power to function. A method for storing energy and converting same to electric power includes providing compressed gas and storing the compressed gas for release to drive a generator. A system and method for storing, disseminating, and utilizing energy in the form of gas compression and expansion comprises a method for expanding compressed gas in at least two stages and further provides for storing energy in the form of compressed gas through compression in at least two stages. Apparatus is provided to operate in accordance with the described procedure.

This is a continuation in part of pending patent application Ser. No. 10/833,958 filed Apr. 28, 2004, which in turn was a continuation-in-part of patent application Ser. No. 09/854,682 filed May 15, 2001, which filing date is hereby claimed.

### BACKGROUND OF THE INVENTION

Generally, we mankind, have had major problems with relation to batteries that is, devices for storing energy for use when desired. The problems include: the charging of batteries, servicing of batteries, the non-reusability of batteries, and the highly dangerous, hazardous, and explosive, environmentally-polluting chemicals used in existing electrochemical batteries, and their heavy weight.

The thermo-dynamic battery storage unit of the invention solves all of these issues. It generates clean, usable energy, while remaining chemical and explosion free, lightweight, rapidly rechargeable, economical, and environmentally-friendly.

The present invention relates generally to a device for use in any application for providing power for any electrical device that employs battery power to function. More explicitly, the present invention discloses an innovative, high power device, which does not generate any harmful, environmentally-polluting residue. The present invention is extremely ecologically compatible in operation and design, actually replenishing clean ozone back into the atmosphere, is long lasting, and is designed to be re-usable unlike conventional units.

### OBJECTS OF THE INVENTION

The present invention relates generally to a new power device. More distinctively, it provides generation of electrical power from compressed gas energy.

Another positive attribute of the present-invention is that the compressed gas is passed through a generator, which exchanges heat with the generator to increase the efficiency of the generator and its driver device. This enhances efficiency of use of energy, that is stored and conserved in the thermo-dynamic battery storage unit in accordance with the invention.

### BRIEF DESCRIPTION OF DRAWINGS

FIG. 1 is a schematic view of a thermo-dynamic battery storage unit in accordance with the invention.

FIG. 2 is a schematic view of a arrangement in accordance with the invention of a plurality of thermo-dynamic storage units.

### SUMMARY OF THE INVENTION

A plurality of compressed gas thermo-dynamic battery storage units is connectable to power a power generating system.

A system for generating power from energy stored in compressed gas includes at least two (2) thermo-dynamic battery storage units connectable in series to one another for controllable release of the gas to drive a generator. A method in accordance with the invention comprises providing at least two (2) thermo-dynamic battery storage units connectable in series with one another for controllable release of the gas to drive a generator.

The present invention provides a unique battery system, which produces from compressed gas energy, clean usable electrical power for use in any application in any device that can employ battery power to operate. The invention is much lighter for the same energy output than existing units, can be charged in rather than hours, and operates chemical and explosion free. Environmentally safe to operate, and operates at or about 90% efficiency.

A system and method in accordance with the invention for storing, disseminating, and utilizing energy in the form of gas compression and expansion comprises a method for storing energy including the steps of providing power to compress gas in at least two stages with at least two pressure changes, to a receptacle where the gas is compressed and held for dissemination to provide power. The method provides for dissemination of stored energy when proceeding in reverse, i.e., when said compressed gas is expanded with at least two pressure changes and the output is coupled to at least one generator. A system in accordance with the invention operates in accordance with said method and employs apparatus to implement said method with at least two expanders coupleable to at least one generator. When operated in the opposite manner, said system provides energy storage in the form of compressed gas.

### DETAILED DESCRIPTION OF THE INVENTION

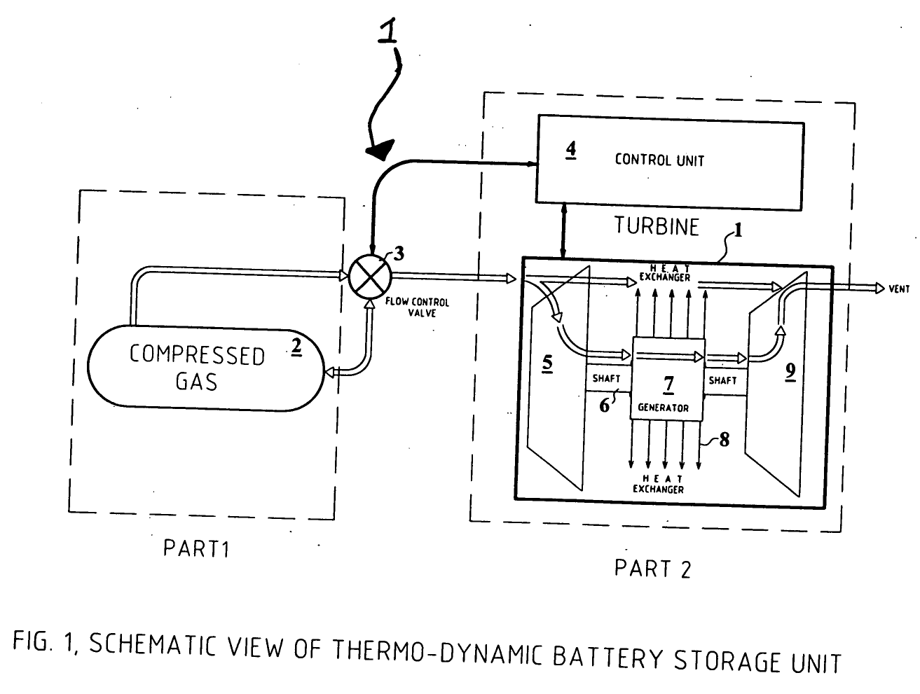

As shown in FIG. 1, a thermodynamic battery storage unit 1 in accordance with the invention comprises a tank 2 for compressed gas, a generator 7 connected with at least two turbine fan sets 5, 9 in series, a heat exchanger chamber 10 and a control unit 4, including a flow control valve 3 for controlling release of compressed gas from tank 2. Tank 2, control unit 4, and generator 7 are of conventional type.

The gas released from tank 2 under control of unit 4 passing through first turbine fan blades set 5 will cause generator 7 to operate, which in turn generates electricity and some incidental heat. Generated heat expands the released gas causing the second set of fan blades 9 to operate, which is transmitted back to generator 7 with a common shaft 6 to operate generator 7.

The released gas is in thermal contact with heat exchanger chamber 10 long enough to achieve expected results. At the same time, the released gas—which under the laws of thermo-dynamics cools as it expands upon release—cools generator 7 and increases generator efficiency thereby. Generating of electricity is thus controlled by control unit 4 and flow control valve 3.

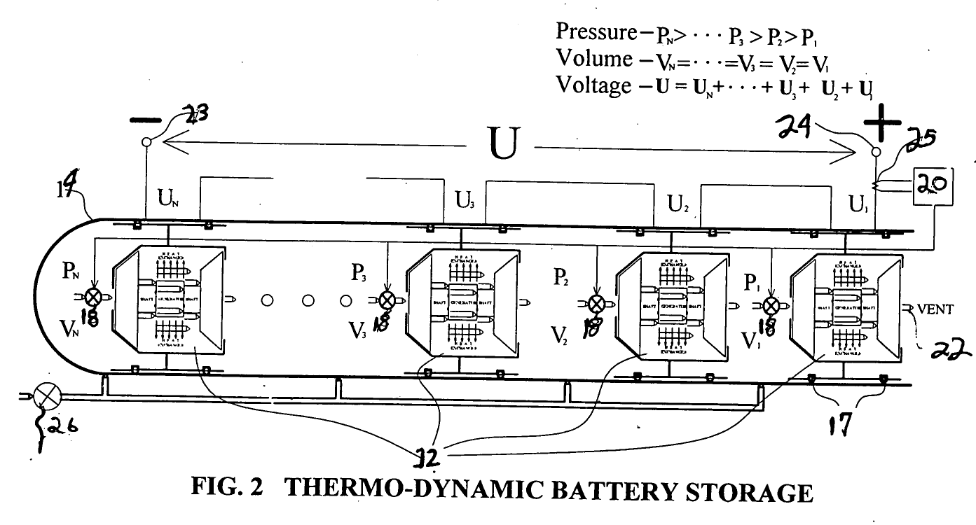

As shown in FIG. 2, a thermo-dynamic storage battery control system 12 comprises a plurality of individual thermo-dynamic storage battery units 12, in the case depicted herein numbering four. This number is provided for specificity; the invention in this embodiment may operate with as few as two individual units as well as with an unlimited number thereof.

Each individual unit 12 operates in the same manner as thermo-dynamic battery storage unit 1 described above. In the present embodiment, the respective units 12 are depicted as connected to one another within a tank 14. Each unit 12 is held in place by conventional means and is sealed by O-rings 17.

Each unit 12 includes a flow control valve 18 controlled by a controller regulator 20. Each unit 12 is filled with compressed gas at a predetermined pressure. As depicted, the unit 12 at the left end of tank 14 is at the highest pressure, shown here as Pₙ, and unit 12 at the right hand end of tank 14 is at the lowest pressure, shown herein as P₁. The P₁ unit 12 is connectable to a vent 22 to ambient. Pressure may be 5000 psi or higher in particular applications.

As depicted in FIG. 2, volume of the Pₙ unit 12 is given as Vₙ. Similar considerations apply to intermediate units 12, whose pressure and volume, respectively, are P₃, V₃ and P_{2,} V_{2.} Pressure in units 12 diminishes from the highest pressure, to the lowest pressure P₁ with intermediate units 12 having diminishing pressure from left to right as shown in FIG. 2. For example, in the specific configuration depicted, P₃ is larger than P_{2,} which in turn is larger than P_{1.}

As further depicted in FIG. 2, each unit 12 contributes power when the system is operated as stated below. For ease of reference, said power—in this case, voltage—is symbolized by Uₙ through U₁. Said individual contributions to the power may be employed in series, for increased voltage or in parallel for increased current.

A charging valve 26 controls charging of tank 14 with compressed gas for storage of energy therein. This may be employed for a fast or booster charge.

In the embodiment depicted in FIG. 2, a negative electrical terminal 23 is disposed at the high pressure end of tank 14 and a positive terminal 24 is disposed of the low pressure end of tank 14. The phrase “high pressure end” and “low pressure end” means in this context the location in tank 14 where, respectively, the highest pressure unit 12 (the Pₙ unit) and the lowest pressure unit 12 (the P₁ unit 12) are located.

In operation, controller regulator 20 is operable to open valves 18 and is subject to load sensor 25 connected hereto. Upon opening of valves 18 compressed gas flows under the influence of differential pressure such that from each unit 12, voltage is generated as described in connection with the system of FIG. 1. Load sensor 25 regulates operation of controller regulator 20 such that for a smaller load valves 18 operate to diminish flow of gas and for higher loads to increase gas flow. Such devices are in common usage at present as, for example, in power generating facilities which seek to maximize efficiency by matching power generation to power demand.

As noted above, the individual power outputs of units 12 can be placed in parallel to provide a larger current or in series for increased voltage. In addition, each unit 12 may be arranged to provide released gas to power a generator (not shown) outside of power units 12 and outside of tank 14.

A method for storing and using energy and employing same for generating electric power includes the steps of: (1) storing energy in the form of compressed gas; (2) controllably releasing said gas to operate a generator. The gas may comprise air, and the gas may pass in thermal contact with a heat exchanger with the generator for improved efficiency.

A method for storing energy and generating power comprises the steps of storing compressed gas for controllable release to drive a power generator and releasing the compressed gas in at least two pressure drops, thereby reducing energy loss from expansion of compressed gas. This method may be implemented by means of the apparatus depicted in FIG. 2 or similar devices. The method of the invention may be employed with a plurality of pressure drops, numbering two or more.

The foregoing-described system and method for storing, disseminating, and utilizing energy in the form of compressed gas, includes a method for storing energy in the form of gas compression by substantially reversing the foregoing-described method for generating power, using the same apparatus. Under the method, power is supplied to generators 12 and as a result they function as motors causing the expanders therein to reverse such that air will be compressed through the above-described pressure changes for storage in tank 14.

Efficiency in the forward cycle as well as the reverse cycle is promoted by the multiple pressure change aspect of the invention.

In the foregoing manner, energy losses from expansion of compressed gases are minimized, and efficiency improved.

The within specification and drawings disclose particular embodiments of the invention, which is defined by the appended claims interpreted in light of the specification and drawings.

1. A device for storing energy and generating electrical power comprising: at least one compressed gas storage device for storing compressed gas and for controllably releasing said gas; at least one generator capable of generating electricity resulting from receiving a flow of gas; said at least one compressed gas storage device being connectable to said at least one generator such that said compressed gas storage device supplies gas flow from gas released therefrom to said at least one generator thereby resulting in electrical power generation.

2. The invention as set forth in claim 1 further including at least one heat exchanger connectable to receive gas flow from said at least one compressed gas storage device and to receive heat from said at least one generator wherein said heat exchanger expands the volume of said gas.

3. The invention as set forth in claim 1, wherein said at least one generator includes at least two turbine members for driving said at least one generator in response to impingement upon said at least two turbine members of gas flow, a first turbine member being arranged to receive gas flow from said at least one compressed gas storage device and a second turbine member being arranged to receive gas flow from said at least one heat exchanger.

4. The invention as set forth in claim 1, wherein said device for storing energy and generating electric power comprises at least one flow control valve and at least one controller, for controllable release of said compressed gas.

5. The invention as set forth in claim 1, including at least one energy source for providing compressed gas for storage in said compressed gas storage device.

6. The invention as set forth in claim 1, wherein said power device for storing energy and generating electric power includes at least one common drive shaft for said generator and said at least two turbine members.

7. The invention as set forth in claim 1, wherein said gas comprises air.

8. A method for storing energy and for generating power comprising the steps of:
(a) Providing compressed gas;
(b) Storing said compressed gas for controllable release to drive at least one power generator.

9. The method as set forth in claim 8 further including the step of releasing at least a portion of said compressed gas thereby driving said at least one power generator to provide power.

10. The method as set forth in claim 8 further including the step of providing means for compressing said gas.

11. The method as set forth in claim 8 wherein said gas is compressed air.

12. A system for storing energy and generating power comprising: At least two compressed gas storage devices comprising at least a first compressed gas storage device and at least a second compressed gas storage device, each of said gas storage devices having means for storing compressed gas and for controllably releasing said gas; generator means capable of generating power resulting from receiving a flow of gas, said first compressed gas storage device having higher operating pressure than said second compressed gas storage device, said first compressed gas storage device and said second gas storage device being connectable to one another such that upon release of gas from said first compressed gas storage device and from said second compressed gas storage device, gas flow proceeds such that the pressure drop across said first compressed gas storage device is substantially equal to the difference in operating pressure between said first compressed gas storage device and said second gas storage device, said first compressed gas storage device and said second compressed gas storage device being connectable to said generator means.

13. The invention as set forth in claim 12 wherein said generator means comprises at least one generator member connected to said first compressed gas storage device.

14. The invention as set forth in claim 12 wherein said generator means comprises at least one generator member disposed at least partially within said first compressed gas storage device.

15. The invention as set forth in claim 12 wherein said generator means comprises at least one generator member connected to said second compressed gas storage device.

16. The invention as set forth in claim 12 wherein said generator means comprises at least one generator member disposed at least partially within said second compressed gas storage device.

17. The invention as set forth in claim 12 further including heat exchanger means connectable to receive gas flow from said first compressed gas storage device and to receive heat from said generator means, wherein said heat exchanger expands the volume of said released gas.

18. The invention as set forth in claim 12 wherein said generator means includes at least two turbine members for driving said generator means in response to impingement upon said at least two turbine members of gas flow, a first turbine member being arranged to receive gas flow from said first compressed gas storage device and a second turbine member being arranged to receive gas flow from said heat exchanger means.

19. The invention as set forth in claim 12 wherein said means for controllably releasing said gas from said first compressed gas storage device comprises at least one controller member and at least one flow control valve for controllable release of said compressed gas.

20. The invention as set forth in claim 12 further including heat exchanger means connectable to receive gas flow from said second compressed gas storage device wherein said heat exchanger expands the volume of said released gas.

21. The invention as set forth in claim 20 wherein said generator means includes at least two turbine members for driving said generator means in response to impingement upon said at least two turbine members of gas flow, a first turbine member being arranged to receive gas flow from said second compressed gas storage device and a second turbine member being arranged to receive gas flow from said heat exchanger means.

22. The invention as set forth in claim 12 wherein said means for controllably releasing said gas from said second compressed gas storage device comprises at least one controller member and at least one flow control valve for controllable release of said compressed gas.

23. The invention as set forth in claim 18 wherein said first compressed gas storage device includes at least one common drive shaft for said generator means and said at least two turbine members.

24. The invention as set forth in claim 21 wherein said second compressed gas storage device includes at least one common drive shaft for said generator means and said at least two turbine members.

25. A system for storing and generating power comprising means for storing energy in the form of compressed gas and connectable to means for generating power in response to flow of gas, said means for storing energy including means for releasing compressed gas in at least two stages such that the pressure drop upon release of said compressed gas is in stages, thereby reducing energy loss from expansion of compressed gas.

26. The invention as set forth in claim 25 wherein said means for storing energy in the form of compressed gas comprises at least a first compressed gas storage member and a second compressed gas storage member, said first compressed gas storage member being connectable to said second compressed gas storage member, said first compressed gas storage member being at a different pressure from said second compressed gas storage member.

27. The invention as set forth in claim 25 wherein said means for storing energy in the form of compressed gas comprises a plurality of compressed gas storage members at differing pressures.

28. A method for storing energy and generating power comprising the steps of:
(a) Storing compressed gas for controllable release to drive power generator means;
(b) Releasing said compressed gas in at least two pressure drops, whereby energy loss due to expansion of compressed gas is reduced.

29. The invention as set forth in claim 28 wherein there is a plurality of pressure drops.

30. The invention as set forth in claim 28 wherein thermal energy released upon generation of power is at least partially returned to said compressed gas to reduce energy loss.

31. The invention as set forth in claim 28 wherein said gas comprises air.

32. A system for storing power comprising means for storing energy in the form of compressed gas and connectable to means for providing power, and further including means for compressing gas through application of power from said power providing means, including means for compressing gas in at least two stages such that the pressure change upon compression of said gas is in at least two stages, thereby reducing energy loss from compression of said gas.

33. The invention as set forth in claim 32 wherein said means for compressing gas comprises at least a first motor member and a second motor member, said first motor member and said second motor member being connectable to one another and operating at different gas pressures.

34. The invention as set forth in claim 32 wherein at least one of said motor members is operable in reverse to function as a generator.

35. The invention as set forth in claim 32 wherein said means for storing energy in the form of compressed gas comprises a plurality of compressed gas storage members at differing pressures.

36. The invention as set forth in claim 32 wherein said motor means includes at least two turbine members operable to drive said gas compression, a first turbine member being arranged to receive gas flow from said means for storing energy in the form of compressed gas, said first motor member and said second turbine member being arranged to receive gas flow from heat exchanger means included in said motor means.

37. The invention as set forth in claim 36 or in said heat exchanger means contributes to controlling temperature of said motor members.

38. The invention as set forth in claim 33 further including at least two compressed gas storage devices, a first of said at least two compressed gas storage devices including said first motor member and a second of said at least two compressed gas storage devices including said second motor member

39. The invention as set forth in claim 38 further including means for controlling gas flow from and to said first compressed gas storage device and further including at least one flow control valve for controlling said gas flow from and to said first compressed gas storage device.

40. The invention as set forth in claim 38 further including means for controlling gas flow from and to said second gas storage device, other than said means for controlling gas flow from and to said first compressed gas storage device and further including at least one flow control valve for controlling gas flow from and to said second compressed gas storage device other than said at least one flow control valve for controlling gas flow from and to said first compressed gas storage device.

41. The invention as set forth in claim 32 wherein said gas substantially comprises air.

42. The invention as set forth in claim 32 wherein said pressure of said compressed stored gas is substantially equal to or greater than 5000 psi.

43. The invention as set forth in claim 32 wherein said pressure of said compressed stored gas is substantially equal or less than 5000 psi.

44. The invention as set forth in claim 32 wherein said pressure changes are substantially equal to one another.

45. A method for storing power in the form of compressed gas comprising the steps of:
a. providing power means;
b. providing means for compressing gas through application of power from said power means, whereby said gas is compressed in at least two stages such that the pressure change upon compression of said gas is in at least two stages, thereby reducing energy loss.

46. The method as set forth in claim 45 wherein said means for compressing gas is operable in reverse to function as a generator.

47. The method as set forth in claim 45 wherein said pressure changes are substantially equal to one another.

48. A system for storing energy and generating electrical power comprising:
a plurality of compressed gas storage devices for storing compressed gas and for controllably releasing said gas;
a tank member substantially containing said plurality of compressed gas storage devices;
means for controlling charging with compressed gas of said plurality of compressed gas storage devices;
at least one generator capable of generating electricity resulting from receiving a flow of gas;
said plurality of compressed gas storage devices being connectable to said at least one generator such that said compressed gas storage devices supply gas flow from gas released therefrom to said at least one generator thereby resulting in electrical power generation;
control means for controlling release of compressed gas; and
load sensor means for sensing load in connection with release of compressed gas, said control means for controlling release of compressed gas being connected with said load sensor means such that for a smaller load gas flow is diminished and for higher loads gas flow is increased.
